(19) United States
(12) Patent Application Publication
(10) Pub. No.: US 2026/0168852 A1
(43) Pub. Date: Jun. 18, 2026

(54) Spectral Camera

(71) Applicant: SEIKO EPSON CORPORATION, Tokyo (JP)

(72) Inventor: Shota YAMANAKA, Matsumoto (JP)

(21) Appl. No.: 19/417,978

(22) Filed: Dec. 12, 2025

(30) Foreign Application Priority Data
Dec. 13, 2024 (JP) 2024-218501

(51) Int. Cl. G01J 3/28; G01J 3/02; G01J 3/26; G02B 1/11; H04N 23/55

(52) U.S. Cl. CPC G01J 3/2823; G01J 3/0208; G01J 3/26; G02B 1/11; H04N 23/55; G01J 2003/2826

(57) ABSTRACT

A spectral camera includes: multiple planar plates including an etalon; a first lens group disposed closer to an object side than the etalon; a second lens group disposed closer to an image side than the etalon; and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, and the number of Fresnel reflection interfaces at which no antireflection film is provided out of Fresnel reflection interfaces of the multiple planar plates, on which the parallel light is incident, being two or smaller.

The present application is based on, and claims priority from JP Application Serial Number 2024-218501, filed Dec. 13, 2024, the disclosure of which is hereby incorporated by reference herein in its entirety.

### BACKGROUND

### 1. Technical Field

The present disclosure relates to a spectral camera.

### 2. Related Art

An imaging camera includes an optical system in which multiple lenses are arranged between an objective lens and an imager, and a planar plate element is incorporated in the optical system in some cases.

In particular, in a spectral camera that is an imaging camera having an optical system in which a wavelength tunable etalon is disposed, the etalon is housed in some cases in a package enclosure having an interior maintained airtight in order to suppress mechanical impact on the etalon and entry of water droplets into the etalon. In this case, the package enclosure needs to have a light incident portion via which light incident on the etalon passes and a light exiting portion via which light exiting out of the etalon passes, and the light incident portion and the light exiting portion are each configured with a planar plate made, for example, of glass (refer to JP-A-2014-142387).

JP-A-2014-142387 is an example of the related art.

In a configuration in which multiple planar plates are incorporated in the optical system of a spectral camera and parallel light is caused to be incident on the planar plates, however, there is a problem of reflection of the light off the interfaces between the planar plates, which causes multiple reflection of the light, resulting in a ghost appearing in a spectral image.

### SUMMARY

A spectral camera according to a first aspect of the present disclosure includes multiple planar plates including an etalon, a first lens group disposed closer to an object side than the etalon, a second lens group disposed closer to an image side than the etalon, and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, and the number of Fresnel reflection interfaces at which no antireflection film is provided out of Fresnel reflection interfaces of the multiple planar plates, on which the parallel light is incident, being two or smaller.

### BRIEF DESCRIPTION OF THE DRAWINGS

FIG. 1 is a diagrammatic view showing a schematic configuration of a spectral camera according to a first embodiment.

FIG. 2 is a diagrammatic view showing a portion of an optical system component in the present embodiment.

FIG. 3 is a cross-sectional view showing a schematic configuration of an etalon, a filter package, and a bandpass filter in the present embodiment.

FIG. 4 is a diagrammatic view showing a ghost generation mechanism in a case where parallel light is incident on multiple planar plates.

FIG. 5 shows an example of a result of a simulation in which the positions of a real image and a ghost image are visualized in a case where no antireflection film is provided at any of the multiple planar plates.

FIG. 6 shows the positions at each of which an antireflection film is disposed in the present embodiment.

FIG. 7 shows an example of a result of the simulation showing the position of a ghost image obtained by performing an optical simulation on the spectral camera according to the present embodiment.

FIG. 8 shows a ghost reduction factor in a case where the antireflection film is provided at a Fresnel reflection interface of each of the planar plates disposed in the spectral camera.

FIG. 9 shows the positions at each of which the antireflection film is disposed in a second embodiment.

FIG. 10 shows the positions at each of which the antireflection film is disposed in a third embodiment.

FIG. 11 shows an example of a result of the simulation in which the positions of a real image and a ghost image of a target object are visualized by performing the optical simulation on a spectral camera according to the third embodiment.

FIG. 12 shows the positions at each of which the antireflection film is disposed in a fourth embodiment.

### DESCRIPTION OF EMBODIMENTS

### First Embodiment

A spectral camera according to a first embodiment of the present disclosure will be described below.

### Overall Configuration of Spectral Camera

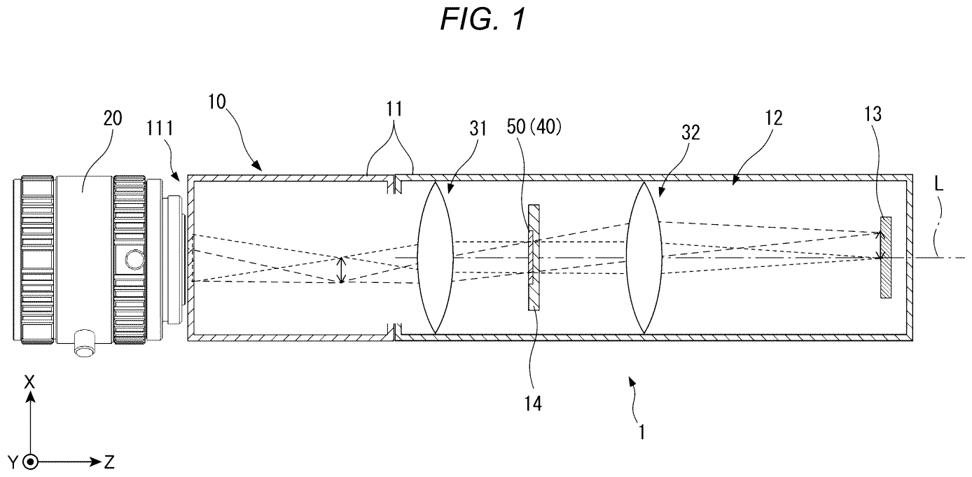

FIG. 1 is a diagrammatic view showing a schematic configuration of the spectral camera according to the first embodiment.

A spectral camera 1 according to the present embodiment includes a camera body 10 and an interchangeable lens 20, which is detachable from the camera body 10.

The camera body 10 includes a camera enclosure 11, an optical system component 12, an imager (image sensor) 13, and a circuit substrate 14, as shown in FIG. 1. The optical system component 12, the imager 13, and the circuit substrate 14 are housed in the camera enclosure 11.

The camera enclosure 11 has a space that houses the optical system component 12, the imager 13, and the circuit substrate 14. The camera enclosure 11 includes fixing mechanisms that fix lenses contained in the optical system component 12, the imager 13, and the circuit substrate 14.

The camera enclosure 11 includes a lens mount 111, which detachably holds the interchangeable lens 20. The spectral camera 1 according to the present embodiment allows any interchangeable lens 20 to be attached to the lens mount 111. Although not shown in FIG. 1, multiple lenses are incorporated in the interchangeable lens 20, and different interchangeable lenses 20 include different lenses. Different interchangeable lenses 20 therefore allow different imaging conditions, for example, the zoom magnification.

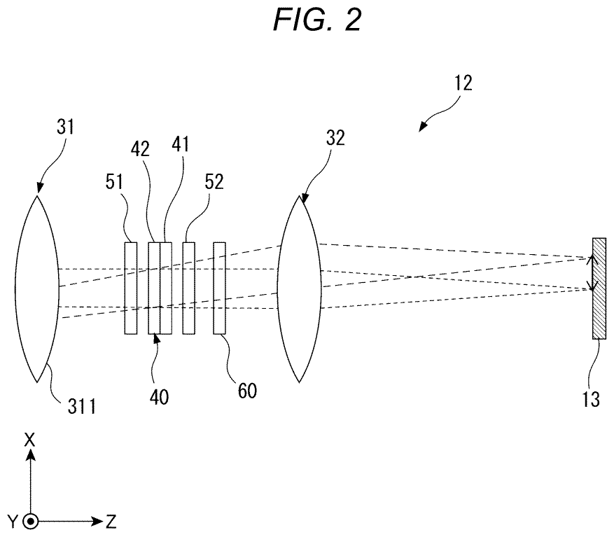

FIG. 2 is a diagrammatic view showing a portion of the optical system component 12.

The optical system component 12 includes a first lens group 31 and a second lens group 32, as shown in FIG. 2. In the following description, it is assumed that an optical axis L of the lenses that constitute the optical system component 12 coincides with the optical axis L of the imager 13, and that a direction along the optical axis L is a Z direction (side facing imager 13 is +Z). A direction perpendicular to the Z direction is defined as an X direction, and a direction perpendicular to the X direction and the Z direction is defined as a Y direction.

The first lens group 31 (+Z-side portion thereof is shown in FIG. 2) guides light incident via the interchangeable lens 20 to an etalon 40 and the second lens group 32. The first lens group 31 includes a collimator optical system 311, which parallelizes incident light, and light parallelized by the collimator optical system 311 passes through the etalon 40 and is guided to the imager 13 via the second lens group 32, as shown in FIG. 2.

The etalon 40 selects a predetermined wavelength from the wavelengths of the incident light, and transmits the light having the predetermined wavelength. The imager 13 therefore receives the light having the predetermined wavelength and having passed through the etalon 40, and captures a spectral image.

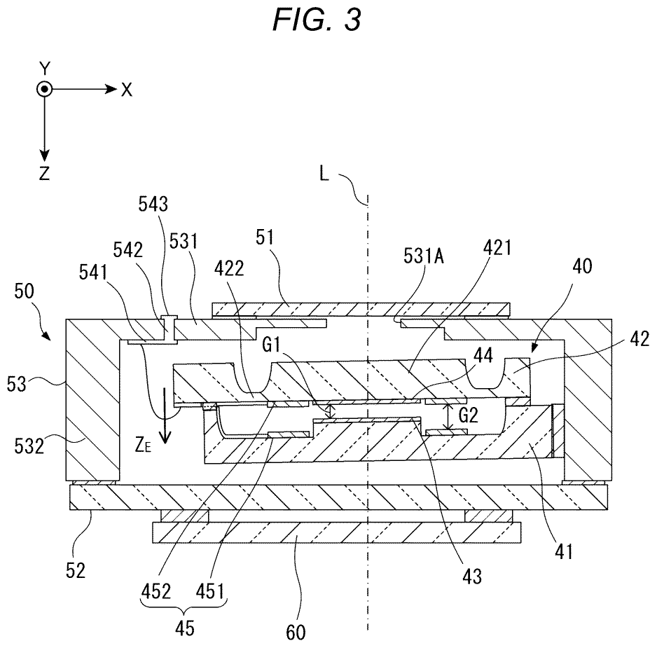

Multiple planar plates are disposed between the first lens group 31 and the second lens group 32. The planar plates include glass substrates (first substrate 41 and second substrate 42, which will be described later) that constitute the etalon 40, a cover glass plate 51 and a lid glass plate 52 provided in a filter package 50 (see FIG. 3), which holds the etalon 40, a bandpass filter 60, which transmits only light in a predetermined wavelength region, and the like.

The etalon 40, the filter package 50, and the bandpass filter 60 will be described later.

The second lens group 32 is an imaging optical system that brings the light having passed through the etalon 40 into focus at the imager 13, and is, for example, a telecentric optical system configured with multiple lenses.

The imager 13 is an image sensor having multiple pixels, receives the light guided by the optical system component 12, and outputs image information on the spectral image.

The circuit substrate 14 is provided with a circuit that controls the operation of driving the imager 13 and the etalon 40. Although not shown, the circuit substrate 14 includes a recording circuit that records various pieces of information, an operation circuit that executes various programs, a driver circuit that controls the operation of driving the imager 13 and the etalon 40, and other circuits.

Multiple circuit substrates 14 may be provided. The example shown in FIG. 1 is a case where the circuit substrate 14 is provided: the circuit substrate 14 to which the filter package 50, which houses the etalon 40, is fixed. In the configuration in which the filter package 50 and the imager 13 are fixed to the circuit substrates 14, the filter package 50 and the imager 13 can be positioned at desired positions in the optical system component 12 (fixing mechanism) by fixing the circuit substrates 14 to predetermined fixation positions in the camera enclosure 11.

### Configuration of Etalon and Filter Package

The etalon 40, the filter package 50, and the bandpass filter 60 will next be described.

FIG. 3 is a cross-sectional view showing a schematic configuration of the etalon 40, the filter package 50, and the bandpass filter 60 in the present embodiment.

In the present embodiment, the etalon 40 is housed in the filter package 50, and the bandpass filter 60 is bonded to the filter package 50, so that the etalon 40, the filter package 50, and the bandpass filter 60 are integrated into a single unit.

The etalon 40 includes a first substrate 41, a second substrate 42, a first reflection film 43, a second reflection film 44, and an actuator 45.

The first substrate 41 and the second substrate 42 are substrates that are transparent to each wavelength of the light that forms the spectral image captured by the spectral camera 1, and are each configured, for example, with a glass substrate when a spectral image formed by light having a predetermined wavelength in a visible light region is captured. Note in a case where a spectral image in the near-infrared region is captured by the spectral camera 1 or any other similar case, the first substrate 41 and the second substrate 42 may each be configured with a substrate made of a material capable of transmitting near-infrared light, such as silicon. The first substrate 41 and the second substrate 42 are bonded to each other via a bonding layer so that the two substrates are integrated into a single unit.

In the present embodiment, the etalon 40 is formed by bonding the first substrate 41 and the second substrate 42 to each other, and a direction in the etalon 40 from the second substrate 42 toward the first substrate 41 is defined as a Z_{E} direction (+Z_{E}).

The first reflection film 43 and a first electrode 451, which constitutes the actuator 45, are provided at a surface of the first substrate 41 that is the surface facing the second substrate 42.

The second reflection film 44 and a second electrode 452, which constitutes the actuator 45, are provided at a surface of the second substrate 42 that is the surface facing the first substrate 41.

A surface of the first substrate 41 that is the surface facing the second substrate 42 has a recess formed, for example, by etching. Therefore, when the first substrate 41 and the second substrate 42 are bonded to each other, the first reflection film 43 and the second reflection film 44 face each other via a predetermined first gap G1, and the first electrode 451 and the second electrode 452 face each other via a predetermined second gap G2.

An recess having, for example, an annular shape is formed at a surface of the second substrate 42 that is the surface opposite the first substrate 41. Out of the second substrate 42, the portion inside the annular recess (substrate central portion) constitutes a movable portion 421, and the annular recess constitutes a diaphragm portion 422, which holds the movable portion 421.

At the second substrate 42, the second reflection film 44 is provided at a surface of the movable portion 421 that is the surface facing the first substrate 41. The second electrode 452 may be provided at the movable portion 421, may be provided at the diaphragm portion 422, or may be provided at a portion extending from the movable portion 421 to the diaphragm portion 422.

The actuator 45, to which a voltage applied, changes the dimension of the first gap G1 between the first reflection film 43 and the second reflection film 44. In the present embodiment, the actuator 45 is an electrostatic actuator, and is configured with the first electrode 451 provided at the first substrate 41 and the second electrode 452 provided at the second substrate 42 and facing the first electrode 451. When a voltage is applied to the space between the first electrode 451 and the second electrode 452, resultant electrostatic attraction bends the diaphragm portion 422, so that the movable portion 421 is displaced toward the first substrate 41. The dimension of the first gap G1 between the first reflection film 43 and the second reflection film 44 thus changes, so that the wavelength of light passing through the etalon 40 changes. Note that since the movable portion 421 is thicker than the diaphragm portion 422, bending of the movable portion 421, that is, bending of the second reflection film 44 is suppressed.

The filter package 50 is a box-shaped enclosure having an internal space maintained in a reduced-pressure environment, and houses the etalon 40 therein.

The filter package 50 includes a base 53 formed in the shape of a container, and the lid glass plate 52, and the base 53 and the lid glass plate 52 are bonded to each other to form the inner housing space, as shown, for example, in FIG. 3.

The base 53 is made, for example, of a ceramic material, and includes a pedestal portion 531 and a sidewall portion 532. The pedestal portion 531 is formed, for example, in the shape of a planar plate having a rectangular outer shape when viewed in the Z direction, and the sidewall portion 532 having a cylindrical shape rises from an outer circumferential portion of the pedestal portion 531 toward the lid glass plate 52.

The pedestal portion 531 is provided with an opening 531A, which passes through the pedestal portion 531 along the Z direction. With the etalon 40 housed in the filter package 50, the opening 531A overlaps with the first reflection film 43 and the second reflection film 44 in a plan view viewed from the Z direction.

The cover glass plate 51, which covers the opening 531A, is bonded to a surface of the pedestal portion 531 that is the surface opposite the lid glass plate 52.

Furthermore, a wiring portion 541, to which the first electrode 451 and the second electrode 452 of the etalon 40 are coupled, is provided at an inner surface of the pedestal portion 531 that is the surface facing the lid glass plate 52. The wiring portion 541 is coupled to an external terminal portion 543, which is disposed at the outer surface of the pedestal portion 531, via a through electrode 542. The external terminal portion 543 is coupled to the driver circuit, which is provided at one of the circuit substrates 14, when the filter package 50 is attached to the circuit substrate 14.

The sidewall portion 532 is formed in the shape of a frame that rises from an edge portion of the pedestal portion 531, and has an end surface opposite the pedestal portion 531 being a planar surface perpendicular to the Z direction, and the lid glass plate 52 is bonded to the end surface. The lid glass plate 52 is, for example, a transparent member having a rectangular outer shape in the plan view and is made, for example, of glass.

In the filter package 50, the etalon 40 is fixed to the sidewall portion 532 of the base 53. In the configuration described above, one end of the first substrate 41 of the etalon 40 is fixed to the sidewall portion 532 via a bonding member 533 having elasticity to form a cantilever structure, as shown in FIG. 3. That is, since the other end of the etalon 40, which is the side not fixed to the filter package 50, is a free end, the Z_{E} direction (direction along optical axis of etalon 40) from the second substrate 42 toward the first substrate 41 of the etalon 40 slightly inclines with respect to the optical axis L (Z direction) of the imager 13. The etalon 40 therefore constitutes the inclining element in the present disclosure. The inclination angle of the inclining element ranges from 0.5 degrees to 5.0 degrees, more preferably, falls within a range from 0.5 degrees to 1.0 degree.

Since the etalon 40 is fixed as described above, vibration from the filter package 50 is unlikely to propagate to the etalon 40.

Out of the light having passed through the etalon 40, the bandpass filter 60 transmits light in the spectrally separated wavelength region of the spectral image and blocks the other light.

That is, a wavelength λ of the light passing through the etalon 40 satisfies the expression below,

$$2 d cos θ = n λ$$

where d represents the dimension of the first gap G1 between the first reflection film 43 and the second reflection film 44, θ represents the angle of incidence of the light incident on the etalon 40, and n represents the order.

In the expression described above, the order n is a positive integer value, and light having wavelengths corresponding to multiple orders passes through the etalon 40. The bandpass filter 60 transmits light having wavelengths in a desired wavelength region (visible light region, for example) out of the wavelengths corresponding to the multiple orders, but blocks light in the other wavelength region.

The bandpass filter 60 may be provided upstream of the etalon 40 (on the side opposite imager 13) or downstream of the etalon 40 (on the side facing imager 13). In the present embodiment, it is assumed that the bandpass filter 60 is bonded to the lid glass plate 52, and that the lid glass plate 52 is disposed closer to the imager 13 than the etalon 40.

### Antireflection Film Provided at Planar Plate Element, and Ghost Suppression Effect

A ghost generated in the spectral camera 1 will be described.

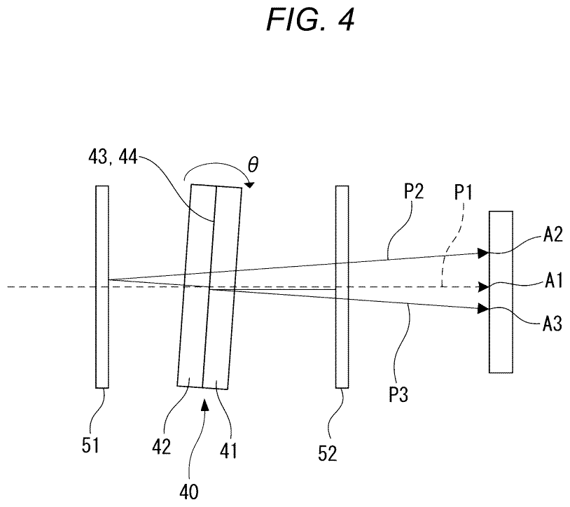

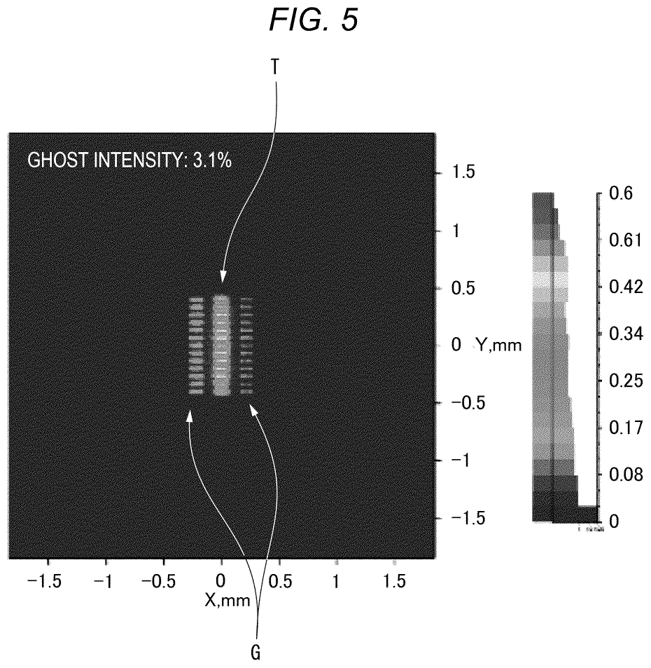

FIG. 4 is a diagrammatic view showing a ghost generation mechanism in a case where parallel light is incident on the multiple planar plates. FIG. 5 shows an example of a result of a simulation in which the positions of a real image and a ghost image of a target object are visualized in a case where no antireflection film is provided at any of the multiple planar plates. The result of the simulation in FIG. 5 shows the position of the real image of the target object obtained by performing an optical simulation on a designed optical system, and the position of the ghost image generated by multiple reflection in the optical system.

The “ghost” generated in the spectral image captured by the spectral camera 1 is generally caused by multiple reflection of the light between the multiple planar plates. In particular, when a portion (etalon 40) of the planar plates inclines with respect to the optical axis L of the imager 13, as in the present embodiment, a ghost is generated at a position different from the position of the real image of the target object. For example, in FIG. 4, a broken line P1 indicates light incident on the imager 13 without undergoing the multiple reflection between the planar plates, and the light is incident on a point A1 on the imager 13. A solid line P2 indicates light reflected off the second reflection film 44 or the first reflection film 43 of the etalon 40, returning toward the cover glass plate 51, and reflected again off the cover glass plate 51, and in this case, the light is incident on a point A2 on the imager 13, which is a point shifted from the point A1. A solid line P3 indicates light passing through the etalon 40, reflected off the lid glass plate 52, and reflected again off the second reflection film 44 or the first reflection film 43 of the etalon 40, and in this case, the light is incident on a point A3 on the imager 13, which is a point shifted from the point A1.

As described above, when the light having undergone the multiple reflection between the inclining planar plate element (inclining element) and another planar plate element is incident on the imager 13, the light is incident on a position shifted from the original incident position. As a result, a ghost G appears in the vicinity of the image (real image T) of the target object in the spectral image, as shown in FIG. 5.

In general, when the intensity of the ghost is 1% or lower, it is difficult to visually recognize the ghost with human eyes, so that the influence on the measurement result is small. The antireflection film may be deposited at a planar plate element in a way that the ghost G having an intensity higher than 1% can be eliminated, but when no antireflection film is provided at any planar plate element, the ghost G having the intensity higher than 1% appears.

To suppress the ghost in the spectral camera 1, it is ideal to provide the antireflection film at each of the planar plates disposed in the spectral camera 1.

However, when the antireflection film is provided at each of the planar plates, the production cost of the antireflection films (for example, cost related to film material of which antireflection films are made, labor related to formation of antireflection films, and the like) increases accordingly. Even when the antireflection film is not provided at each of the planar plates, a ghost, for example, weak enough not to be recognized with human eyes does not affect the measurement. In view of the facts described above, in the spectral camera 1 according to the present disclosure, to make the production cost as low as possible and suppress the ghost to be weak enough not to affect the measurement accuracy, the antireflection film is provided at a planar plate element as will be described below.

That is, in the present embodiment, out of Fresnel reflection interfaces of the five planar plates, the first substrate 41, the second substrate 42, the cover glass plate 51, the lid glass plate 52, and the bandpass filter 60, the number of the Fresnel reflection interfaces at which no antireflection film is provided is set at two or smaller.

The first reflection film 43 and the first electrode 451 are provided at a surface of the first substrate 41 of the etalon 40 that is the surface facing the second substrate 42, and the second reflection film 44 and the second electrode 452 are provided at a surface of the second substrate 42 that is the surface facing the first substrate 41. The surface of the first substrate 41 that faces the second substrate 42 and the surface of the second substrate 42 that faces the first substrate 41 are therefore excluded from the surfaces at which the antireflection film is formed. That is, the antireflection film is provided at each of six or seven surfaces out of the eight surfaces, a surface of the first substrate 41 that is the surface facing the lid glass plate 52, a surface of the second substrate 42 that is the surface facing the cover glass plate 51, the opposite surfaces (±Z surfaces) of the cover glass plate 51, the opposite surfaces (±Z surfaces) of the lid glass plate 52, and the opposite surfaces (±Z surfaces) of the bandpass filter 60.

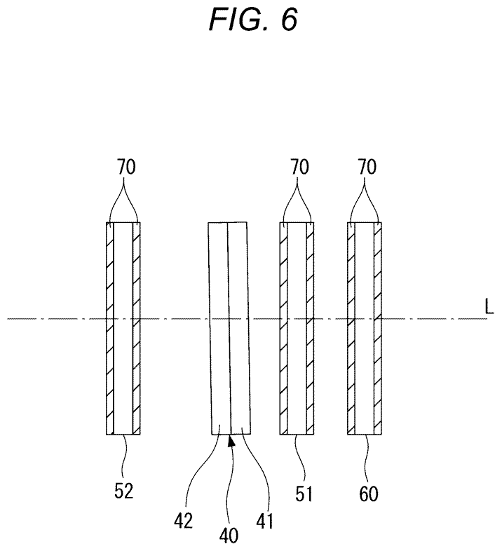

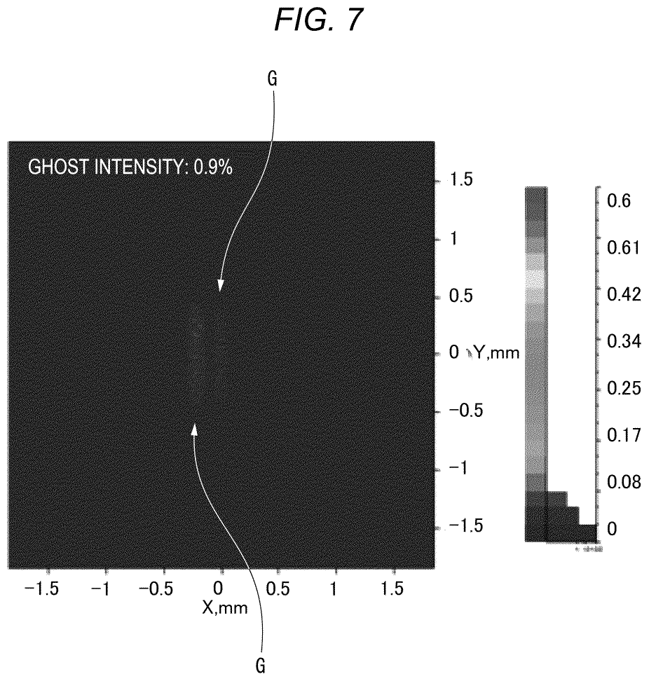

FIG. 6 shows the positions at each of which the antireflection film 70 is disposed in the present embodiment, and FIG. 7 shows an example of a result of the simulation in which the position of a ghost image is visualized by performing the optical simulation on the spectral camera 1 according to the present embodiment.

In the present embodiment, the antireflection films 70 are so provided that the number of Fresnel reflection interfaces at which no antireflection film 70 is provided out of the Fresnel reflection interfaces of the multiple planar plates is two or smaller, and in the example shown in FIG. 6, the antireflection films 70 are formed at the opposite surfaces of the cover glass plate 51, the opposite surfaces of the lid glass plate 52, and the opposite surfaces of the bandpass filter 60, as described above. Therefore, the Fresnel reflection interfaces at which no antireflection film 70 is provided are only a surface of the first substrate 41 that is the surface facing the lid glass plate 52 and a surface of the second substrate 42 that is the surface facing the cover glass plate 51.

The antireflection films 70 can each be a typically used antireflection film. That is, the antireflection films 70 are each formed by stacking multiple optical layers having refractive indices different from each other to deposit a film having a Fresnel reflectance of 0.5% or lower with respect to the wavelength region of the spectral image captured by the spectral camera 1. For example, in the present embodiment, the spectral camera 1 captures a spectral image at each wavelength in the visible light region. In this case, an antireflection film 70 characterized by having a reflectance of 0.5% or lower with respect to the visible light region ranging from 400 nm to 700 nm is formed.

Comparison between FIGS. 7 and 5 shows that when the spectral camera 1 according to the present embodiment is used, the intensity of the ghost G is reduced to a sufficiently small value as compared with the optical system shown in FIG. 5, in which no antireflection film is provided.

Note that in the present embodiment, in which the number of Fresnel reflection interfaces at which no antireflection film 70 is provided out of the Fresnel reflection interfaces of the multiple planar plates is two or smaller, the planar plates at which the antireflection film 70 is provided is not limited to those in the example shown in FIG. 6.

For example, the antireflection film 70 is provided at none of the opposite surfaces of the lid glass plate 52, but may be provided at each of the other planar plates, that is, the opposite surfaces of the cover glass plate 51, a surface of the first substrate 41 that is the surface facing the cover glass plate 51, a surface of the second substrate 42 that is the surface facing the lid glass plate 52, and the opposite surfaces of the bandpass filter 60. An example of the spectral image in this case is not shown, but a spectral image substantially similar to that in FIG. 6 can be obtained.

### Effects and Advantages of Present Embodiment

The spectral camera 1 according to the present embodiment includes the multiple planar plates including the etalon 40 (cover glass plate 51, lid glass plate 52, bandpass filter 60, and etalon 40), the first lens group 31 disposed closer to the object side than the etalon 40, the second lens group 32 disposed closer to the image side than the etalon 40, and the imager 13, which receives the light having passed through the etalon 40 and the second lens group 32. Parallel light collimated by the first lens group 31 is incident on the multiple planar plates, and the second lens group 32 constitutes an imaging optical system that brings the light having passed through the multiple planar plates into focus at the imager 13. The multiple planar plates, on which the parallel light is incident, are so configured that the number of Fresnel reflection interfaces at which no antireflection film 70 is provided out of the Fresnel reflection interfaces of the multiple planar plates is two or smaller.

In the configuration described above, since the number of Fresnel reflection interfaces at which no antireflection film 70 is provided is two or smaller, multiple reflection of the light between the planar plates is suppressed. Generation of a ghost can thus be suppressed. Furthermore, the production cost can be reduced as compared with the case where the antireflection film is provided at each of the planar plates.

In the spectral camera 1 according to the present embodiment, the antireflection film 70 is formed by stacking multiple thin films having refractive indices different from each other, and has the Fresnel reflectance of 0.5% or lower with respect to the wavelength range of the visible light region.

The spectral camera can therefore capture a spectral image affected by a ghost only at a small degree.

### Second Embodiment

A second embodiment of the present disclosure will next be described.

In the following description, the elements having already been described have the same reference characters, and descriptions thereof will be omitted or simplified.

In the first embodiment described above, generation of a ghost is suppressed by employing the configuration in which the number of Fresnel reflection interfaces at which no antireflection film 70 is provided out of the Fresnel reflection interfaces of the multiple planar plates provided in the spectral camera 1 is two or smaller.

In contrast, the second embodiment differs from the first embodiment in that the antireflection film 70 is formed at the planar plates located closer to the image side than the etalon 40.

Note that the spectral camera 1 according to the present embodiment is configured in the same manner as the spectral camera 1 according to the first embodiment described above, but differs therefrom only in terms of the planar plates at which the antireflection film 70 is provided. The spectral camera 1 according to the second embodiment is therefore configured in the same manner as the spectral camera 1 according to the first embodiment shown in FIGS. 1 to 3.

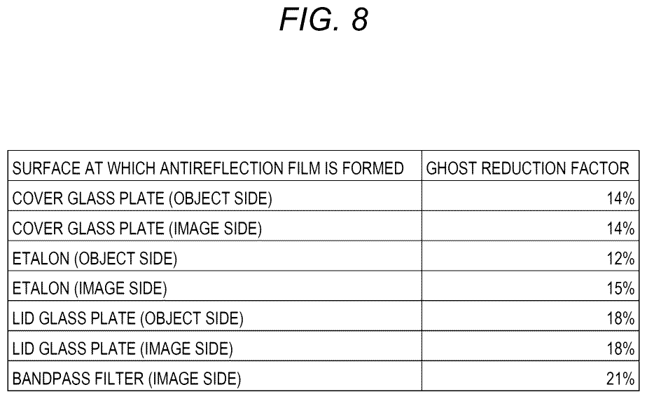

FIG. 8 shows a ghost reduction factor in a case where the antireflection film 70 is provided at the Fresnel reflection interface of each of the planar plates disposed in the spectral camera 1. FIG. 8 shows how much the ghost can be reduced as compared with the case where the antireflection film 70 is provided at none of the planar plates.

In FIG. 8, a surface denoted as “object side” refers to a surface facing a target object an image of which is captured by the spectral camera 1, that is, a −Z-side surface in FIG. 1, and a surface denoted as “image side” refers to a surface facing an image formed at the imager 13, that is, a +Z-side surface in FIG. 1. For example, the “cover glass plate (object side)” refers to a surface of the cover glass plate 51 that is the surface on the side (−Z side) opposite the etalon 40, and the “cover glass plate (image side)” refers to the +Z-side surface of the cover glass plate 51, which is the surface facing the etalon 40. The “etalon (object side)” refers to the −Z_{E}-side surface of the second substrate 42, which is the surface facing the cover glass plate 51. The “etalon (image side)” refers to the +Z_{E}-side surface of the first substrate 41, which is the surface facing the lid glass plate 52.

In the spectral camera 1, when the Fresnel reflection interface of a planar plate element is present at a position shifted from the etalon 40 toward the image side, the light reflected off the Fresnel reflection interface enters the etalon 40 from the image side. The incident light is reflected off the first reflection film 43 of the etalon 40 toward the image side, probably resulting in a ghost. In contrast, the light incident on the etalon 40 from the object side and reflected off the second reflection film 44 of the etalon 40 toward the object side is not incident on the imager 13, so that a planar plate element on the object side has a small ghost contribution factor.

The antireflection film 70 provided at a planar plate element disposed closer to the image side than the etalon 40 out of the planar plates therefore has a ghost reduction contribution factor higher than the factor in a case where the antireflection film 70 is provided at a planar plate element disposed on the object side.

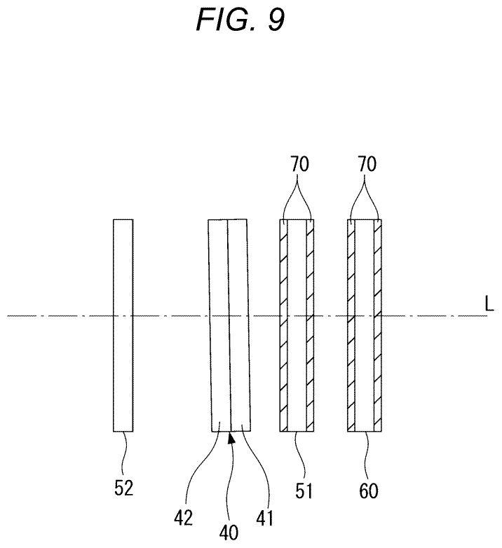

FIG. 9 shows the positions where the antireflection film 70 is disposed in the present embodiment.

In the present embodiment, the antireflection film 70 is provided at the opposite surfaces of the lid glass plate 52 and the opposite surfaces of the bandpass filter 60, which are planar plates having a high ghost reduction contribution factor, that is, planar plates disposed closer to the image side than the etalon 40.

### Effects and Advantages of Present Embodiment

The spectral camera 1 according to the present embodiment includes the multiple planar plates including the etalon 40 (cover glass plate 51, lid glass plate 52, bandpass filter 60, and etalon 40), the first lens group 31 disposed closer to the object side than the etalon 40, the second lens group 32 disposed closer to the image side than the etalon 40, and the imager 13, which receives the light having passed through the etalon 40 and the second lens group 32. Parallel light collimated by the first lens group 31 is incident on the multiple planar plates, and the second lens group 32 constitutes an imaging optical system that brings the light having passed through the multiple planar plates into focus at the imager 13. The antireflection film 70 is provided at each of the planar plates (lid glass plate 52, bandpass filter 60) disposed closer to the imager (image side) than the etalon 40.

The multiple reflection of the light at the planar plates disposed closer to the image side than the etalon and having a high ghost formation contribution factor, is thus suppressed. Therefore, generation of a ghost due to the multiple reflection of the light at the Fresnel reflection interface of each of the planar plates can be suppressed, and the production cost can be reduced as compared with the case where the antireflection film is provided at each of the planar plates, as in the first embodiment.

The multiple reflection of the light at the planar plates disposed closer to the image side than the etalon and having a high ghost formation contribution factor, is thus suppressed. Therefore, generation of a ghost due to the multiple reflection of the light at the Fresnel reflection interface of each of the planar plates can be suppressed, and the production cost can be reduced as compared with the case where the antireflection film is provided at each of the planar plates, as in the first embodiment.

### Third Embodiment

A third embodiment of the present disclosure will next be described.

In the first embodiment described above, generation of a ghost is suppressed by employing the configuration in which the number of Fresnel reflection interfaces at which no antireflection film 70 is provided out of the Fresnel reflection interfaces of the multiple planar plates provided in the spectral camera 1 is two or smaller, and in the second embodiment, generation of a ghost is suppressed by providing the antireflection film 70 at the plate elements disposed closer to the image side than the etalon 40.

In contrast, in the third embodiment, the antireflection film is provided at a planar plate element inclining with respect to the optical axis L out of the multiple planar plates.

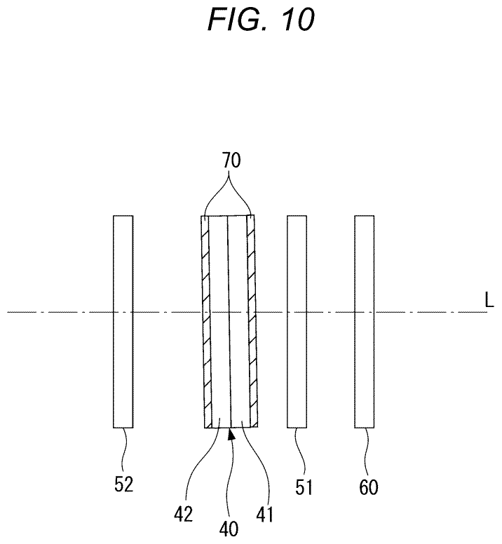

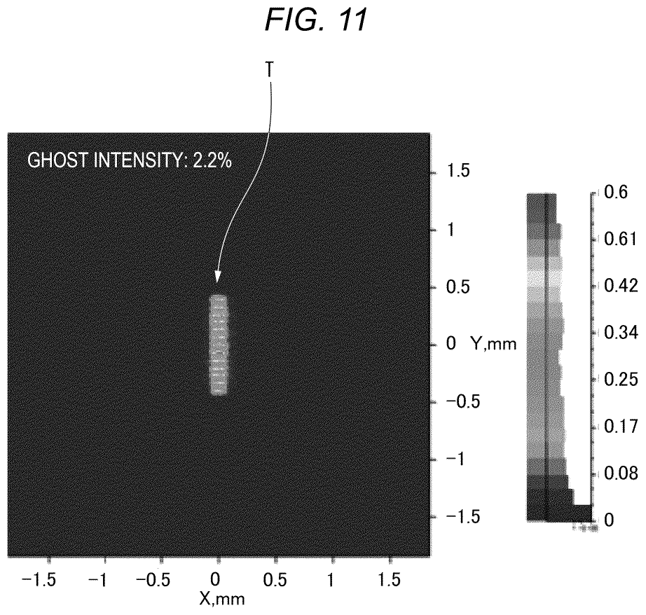

FIG. 10 shows the positions where the antireflection film 70 is disposed in the third embodiment. FIG. 11 shows an example of a result of the simulation in which the positions of a real image and a ghost image of a target object are visualized by performing the optical simulation on the spectral camera 1 according to the third embodiment.

In the present embodiment, the antireflection film 70 is provided at each of the image-side surface and the object-side surface of the etalon 40 inclining by the angle θ with respect to the optical axis L of the imager 13, as shown in FIG. 10. That is, the antireflection film 70 is provided at each of the +Z_{E} surface of the first substrate 41, which is the surface facing the lid glass plate 52, and the −Z_{E} surface of the second substrate 42, which is the surface facing the cover glass plate 51.

In this case, the multiple reflection between the etalon 40 and the planar plates (cover glass plate 51 and lid glass plate 52, for example) disposed upstream and downstream of the etalon 40 is suppressed. That is, the multiple reflection between the first substrate 41 of the etalon 40 inclining with respect to the optical axis L and the planar plate element facing the first substrate 41 is suppressed, and the multiple reflection between the second substrate 42 of the etalon 40 and the planar plate element facing the second substrate 42 is suppressed. Formation of the ghost G in the vicinity of the real image T is therefore suppressed, as can be seen from the result of the simulation shown in FIG. 11.

The configuration described above does not satisfy the condition that the number of Fresnel reflection interfaces at which no antireflection film 70 is provided is two or smaller, unlike in the first embodiment, so that the ghost G having the intensity of 1% or higher is in practice formed at the position where the real image T is formed. However, the ghost G overlaps with the real image T, so that the degree of influence on the measurement is extremely small.

### Effects and Advantages of Present Embodiment

The spectral camera 1 according to the present embodiment includes the multiple planar plates including the etalon 40 (cover glass plate 51, lid glass plate 52, bandpass filter 60, and etalon 40), the first lens group 31 disposed closer to the object side than the etalon 40, the second lens group 32 disposed closer to the image side than the etalon 40, and the imager 13, which receives the light having passed through the etalon 40 and the second lens group 32. Parallel light collimated by the first lens group 31 is incident on the multiple planar plates, and the second lens group 32 constitutes an imaging optical system that brings the light having passed through the multiple planar plates into focus at the imager 13. The optical axis (parallel to Z_{E} direction) of the etalon 40 inclines with respect to the optical axis of the imager 13, and the antireflection films 70 are provided at the etalon 40.

The reflection of the light off the first substrate 41 and the second substrate 42 of the etalon 40 is thus suppressed, so that even when the ghost G is formed, the ghost overlaps with the real image T, which reduces the influence of the ghost G on the measurement accuracy.

### Fourth Embodiment

A fourth embodiment of the present disclosure will next be described.

The above third embodiment has been described with reference to the case where the antireflection films 70 are provided at the etalon 40 inclining by the angle θ with respect to the optical axis L of the imager 13, and the antireflection film may be provided at planar plates disposed upstream and downstream of the etalon 40.

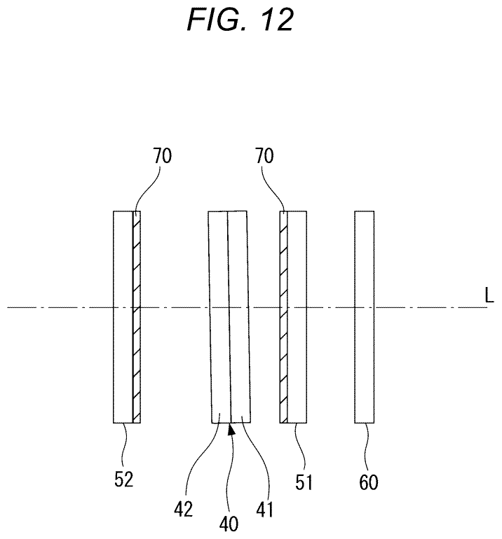

FIG. 12 shows the planar plates and the antireflection films 70 provided at planar plates in the fourth embodiment.

In the present embodiment, the antireflection film 70 is provided at the cover glass plate 51 disposed closer to the object side than the etalon 40 inclining by the angle θ with respect to the optical axis L of the imager 13, and the lid glass plate 52 disposed closer to the image side than the etalon 40, as shown in FIG. 12. That is, the antireflection film 70 is provided at each of the +Z surface of the cover glass plate 51 and the −Z surface of the lid glass plate 52.

In this case, reflection of the light off the lid glass plate 52 is suppressed, so that the multiple reflection of the light between the lid glass plate 52 and the first substrate 41 or the first reflection film 43 is suppressed. Similarly, since the reflection of the light off the second substrate 42 or the second reflection film 44 toward the cover glass plate 51 is suppressed, the multiple reflection of the light between the cover glass plate 51 and the second substrate 42 or the second reflection film 44 is suppressed.

Therefore, even when the ghost G having the intensity of 1% or higher is formed, the position where the ghost G is formed overlaps with the position where the real image T is formed, so that the degree of influence on the measurement is extremely low, as in the third embodiment.

### Effects and Advantages of Present Embodiment

The spectral camera 1 according to the present embodiment includes the multiple planar plates including the etalon 40 (cover glass plate 51, lid glass plate 52, bandpass filter 60, and etalon 40), the first lens group 31 disposed closer to the object side than the etalon 40, the second lens group 32 disposed closer to the image side than the etalon 40, and the imager 13, which receives the light having passed through the etalon 40 and the second lens group 32. Parallel light collimated by the first lens group 31 is incident on the multiple planar plates, and the second lens group 32 constitutes an imaging optical system that brings the light having passed through the multiple planar plates into focus at the imager 13. The optical axis (parallel to Z_{E} direction) of the etalon 40 inclines with respect to the optical axis of the imager 13, and the antireflection film 70 is provided at the cover glass plate 51 provided upstream of the etalon 40 and the lid glass plate 52 provided downstream of the etalon 40.

The reflection of the light between the first substrate 41 and the lid glass plate 52, and between the second substrate 42 and the cover glass plate 51 is thus suppressed, so that even when the ghost G is formed, the ghost overlaps with the real image T, which reduces the influence of the ghost G on the measurement accuracy, as in the third embodiment.

### VARIATIONS

The present disclosure is not limited to the embodiments described above, and includes variations presented below to the extent that the advantages of the present disclosure can be achieved.

### Variation 1

The above embodiments have each been described with reference to the case where the bandpass filter 60 is disposed closer to the imager 13 than the etalon 40, and the bandpass filter 60 may be disposed closer to the object side than the etalon 40.

That is, the light reflected off the Fresnel reflection interface of the planar plate element disposed closer to the image side than the etalon 40 is highly likely to form a ghost, as described in the second embodiment. Therefore, a configuration in which no planar plate element is disposed closer to the image side than the etalon 40 when possible may be employed. Employing the configuration in which the bandpass filter 60 is disposed closer to the object side (−Z side) than the etalon 40 can therefore more effectively suppress generation of a ghost.

### Variation 2

The above embodiments have each been described with reference to the case where the etalon 40, the cover glass plate 51, the lid glass plate 52, and the bandpass filter 60 are presented as the multiple planar plates, and another planar plate element may be disposed. In this case, the another planar plate element may be disposed at a position closer to the object side than the etalon 40.

### Variation 3

The above embodiments have each been described with reference to the case where the inclining element in the present disclosure is the etalon 40, but not necessarily. For example, the Z_{E} direction of the etalon 40 may be maintained in parallel to the optical axis L (Z direction). Furthermore, any of the planar plates excluding the etalon 40 may be the inclining element inclining with respect to the optical axis L. Even in this case, the influence of the ghost can be suppressed by employing the configuration in which the number of Fresnel reflection interfaces at which no antireflection film 70 is provided out of the Fresnel reflection interfaces of the multiple planar plates is two or smaller, as shown in the first embodiment. Instead, the influence of the ghost can also be suppressed by disposing the inclining element upstream (object side) of the etalon 40, as in the second embodiment. Still instead, the antireflection film may be formed at the inclining element, as in the third embodiment, or the antireflection film may be formed at the planar plates disposed upstream and downstream of the inclining element, as in the fourth embodiment.

### Summary of Present Disclosure

A spectral camera according to a first aspect of the present disclosure includes multiple planar plates including an etalon, a first lens group disposed closer to an object side than the etalon, a second lens group disposed closer to an image side than the etalon, and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, and the number of Fresnel reflection interfaces at which no antireflection film is provided out of Fresnel reflection interfaces of the multiple planar plates, on which the parallel light is incident, being two or smaller.

Therefore, generation of a ghost due to multiple reflection of the light at the Fresnel reflection interface of each of the planar plates can be suppressed, and the production cost can be reduced as compared with a case where the antireflection film is provided at each of the planar plates.

A spectral camera according to a second aspect of the present disclosure includes multiple planar plates including an etalon, a first lens group disposed closer to an object side than the etalon, a second lens group disposed closer to an image side than the etalon, and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, and an antireflection film is provided at one or more of the multiple planar plates disposed closer to the imager than the etalon.

The multiple reflection of the light at the planar plates disposed closer to the image side than the etalon and having a high ghost formation contribution factor, is thus suppressed. Therefore, generation of a ghost due to the multiple reflection of the light at the Fresnel reflection interface of each of the planar plates can be suppressed, and the production cost can be reduced as compared with the case where the antireflection film is provided at each of the planar plates, as in the first aspect.

A spectral camera according to a third aspect of the present disclosure includes multiple planar plates including an etalon, a first lens group disposed closer to an object side than the etalon, a second lens group disposed closer to an image side than the etalon, and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, at least one of the multiple planar plates is an inclining element having an optical axis inclining with respect to an optical axis of the imager, and an antireflection film is provided at the inclining element.

The reflection of the light off the inclining element is thus suppressed, so that even when a ghost is formed, the ghost overlaps with a real image, which reduces the influence of the ghost on measurement accuracy.

A spectral camera according to a fourth aspect of the present disclosure includes multiple planar plates including an etalon, a first lens group disposed closer to an object side than the etalon, a second lens group disposed closer to an image side than the etalon, and an imager configured to receive light passing through the etalon and the second lens group, parallel light collimated by the first lens group being incident on the multiple planar plates, the second lens group constituting an imaging optical system configured to bring light passing through the multiple planar plates into focus at the imager, at least one of the multiple planar plates is an inclining element having an optical axis inclining with respect to an optical axis of the imager, and an antireflection film is provided at each of the planar plates disposed upstream and downstream of the inclining element.

Therefore, even when the light is reflected off the inclining element, multiple reflection of the light between the inclining element and the planar plate element provided upstream of the inclining element is suppressed, and multiple reflection of the light between the inclining element and the planar plate element provided downstream of the inclining element is suppressed. Therefore, even when a ghost is formed, the ghost overlaps with a real image, which reduces the influence of the ghost on measurement accuracy.

In the spectral camera according to any of the aspects described above, the antireflection film is formed by stacking multiple thin films having refractive indices different from each other, and has Fresnel reflectance of 0.5% or lower with respect to a wavelength range of a visible light region.

The spectral camera can therefore capture a spectral image affected by a ghost only at a small degree.

What is claimed is:

1. A spectral camera comprising:
multiple planar plates including an etalon;
a first lens group disposed closer to an object side than the etalon;
a second lens group disposed closer to an image side than the etalon; and
an imager configured to receive light passing through the etalon and the second lens group,
wherein parallel light collimated by the first lens group is incident on the multiple planar plates,
the second lens group constitutes an imaging optical system configured to bring light passing through the multiple planar plates into focus at the imager, and
the number of Fresnel reflection interfaces at which no antireflection film is provided out of Fresnel reflection interfaces of the multiple planar plates, on which the parallel light is incident, is two or smaller.

2. A spectral camera comprising:
multiple planar plates including an etalon;
a first lens group disposed closer to an object side than the etalon;
a second lens group disposed closer to an image side than the etalon; and
an imager configured to receive light passing through the etalon and the second lens group,
wherein parallel light collimated by the first lens group is incident on the multiple planar plates,
the second lens group constitutes an imaging optical system configured to bring light passing through the multiple planar plates into focus at the imager, and
an antireflection film is provided at one or more of the multiple planar plates disposed closer to the imager than the etalon.

3. A spectral camera according to the claim 2, wherein
at least one of the multiple planar plates is an inclining element inclining with respect to an optical axis of the imager, and
an antireflection film is provided at the inclining element.

4. A spectral camera according to the claim 3, wherein
the antireflection film is provided at each of the planar plates disposed upstream and downstream of the inclining element.

5. The spectral camera according to claim 3, wherein
an inclination angle between an optical axis of the inclining element and a principal ray of the parallel light is greater than 0.5 degrees.

6. The spectral camera according to claim 1, wherein
the antireflection film is formed by stacking multiple thin films having refractive indices different from each other, and has Fresnel reflectance of 0.5% or lower with respect to a wavelength range of a visible light region.
